(19) United States
(12) Patent Application Publication
(10) Pub. No.: US 2006/0103094 A1
(43) Pub. Date: May 18, 2006

(54) Pallet cart

(76) Inventors: James W. Wiff, Cologne, MN (US); Andrew Leonard Dvorak, Minnetonka, MN (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/262,670

(22) Filed: Oct. 31, 2005

Related U.S. Application Data
(60) Provisional application No. 60/624,520, filed on Nov. 1, 2004.

(51) Int. Cl. B62B 5/00

(52) U.S. Cl. 280/79.11

(57) ABSTRACT

The present invention is a pallet cart adapted to transport a loaded pallet to a location within a facility and/or transport loose materials from said location. The pallet cart comprises a base frame, a plurality of castor wheels, a first sidewall and a second sidewall. The base frame includes a front frame side, a rear frame side, a hitch, a hitch tongue pivotally extending from the base frame, and a means for coupling the pallet cart to a second pallet cart to form a single extended pallet cart for moving items having an extended length. Each castor wheel is coupled to the base frame and pivotal about an axis extending vertically downward from the base frame. A castor locking mechanism interacts with said means for coupling to prevent a castor wheel from pivoting about its axis when the pallet cart is coupled to a second pallet cart to form an extended pallet cart. The first sidewall is pivotally coupled to the front frame side and adapted to pivot from a vertical position to a horizontal position to be folded within the base frame. Similarly, the second sidewall is pivotally coupled to the rear frame side and adapted pivot from a vertical position to a horizontal position to be folded within the base frame. When the sidewalls are folded down within the base frame, a loaded pallet may be placed on the pallet cart. The pallet cart is adapted to be hitched to a powered pulling device and/or other pallet carts via the hitch tongue. Thus, multiple loaded pallets may be moved in one trip when multiple pallet carts, which are each loaded with a loaded pallet, are hitched in a train-like manner to a powered pulling device that is used to pull the sting of loaded pallet carts to a location within the facility.

### CROSS-REFERENCE TO RELATED APPLICATIONS

The present application claims priority to U.S. Provisional Patent Application 60/624,520, which was filed Nov. 1, 2004 and is hereby incorporated in its entirety into the present application.

### FIELD OF THE INVENTION

The present invention relates to devices for, and methods of, transferring products within factory, warehouse and retail facilities. More specifically, the present invention relates to devices for, and methods of, transferring pallets within factory, warehouse and retail facilities.

### BACKGROUND OF THE INVENTION

Everyday, trucks and railcars deliver products to the loading docks of factory, warehouse and retail facilities throughout the world. Often, these products arrive on pallets or are offloaded onto pallets for distribution throughout the facility. Forklifts or pallet jacks are then utilized to move the pallets to their final locations within facility.

Using a pallet to hold products and then moving the pallet through a facility with a forklift or pallet jack is advantageous over manually carrying individual products or boxes of products. However, this method of moving products within a facility leaves room for considerable improvement with respect to safety and efficiency.

Forklifts are less than ideal for moving pallets long distances. For example, where a forklift is utilized to move a loaded pallet and the forklift is driven forward with the loaded pallet in front of the forklift operator, the loaded pallet typically ends up blocking some or all of the operator's forward-looking view. While the operator can drive the forklift in reverse in order to have a better view of where he is going, this requires the operator to twist his body around to look backwards while driving in reverse.

Pallet jacks are also less than ideal for moving pallets long distances. For example, using a pallet jack can require significant physical effort on the part of the pallet jack user. This can lead to the pallet jack user becoming injured. While a motorized pallet jack reduces the required physical effort, its visibility issues are not significantly improved over those of the forklift.

Another disadvantage of forklifts and pallet jacks is that most forklifts and pallet jacks will only move a single loaded pallet at one time. In facilities where many pallets of product are received, a person must make many repeat trips with the forklift or pallet jack. This requires a significant amount of time.

While some forklifts or pallet jacks may have special forks that allow multiple pallets to be moved in one trip, moving multiple numbers of pallets at once further compounds the forward-looking visibility issues already discussed. Also, with multiple pallets on a forklift or pallet jack, maneuverability and aisle width become issues because of the greater width and/or length of the forklift/pallet jack and its multiple pallets.

Often, pallets have products that have widths that exceed the width of an aisle. If a forklift is not fully capable of lifting a pallet from its end in order to clear shelves or structures defining a narrow aisle, then the product must be dragged lengthwise on the pallet down the aisle into its final location. This can be time consuming and increases the likelihood of damage to the product.

Once the products on a pallet have been delivered to a final location within the facility, the products may be removed from their packing material (e.g., card board or other types of boxes, plastic bags, shrink wrap, padding materials, etc.). This packing material then needs to be hauled away to the facility's trash disposal site. The pallets and their forklifts/pallet jacks do not provide an easy means of removing the packing materials to the trash disposal site and, as a result, are typically not used for this purpose. Instead, the packing material is stuffed inside other packing material boxes/bags and the boxes/bags are stacked on four-wheel carts that are pushed or pulled back to the trash disposal site. At times the amount of packing material to be removed is large and requires many trips with the four-wheel carts.

There is a need in the art for a device that will increase the efficiency and safety of transporting products on pallets in factory, warehouse and retail facilities. There is also a need in the art for a more efficient and safe method of transporting products on pallets in factory, warehouse and retail facilities.

### BRIEF SUMMARY OF THE INVENTION

The present invention, in one embodiment, is a pallet cart adapted to transport a loaded pallet to a location within a facility and/or transport loose materials from said location. The pallet cart comprises a base frame, a plurality of castor wheels, a first sidewall and a second sidewall. The base frame includes a front frame side and a rear frame side. Each castor wheel is vertically pivotally coupled to the base frame about an axis or post vertically extending downward from the bottom of the base frame. The first sidewall is pivotally coupled to the front frame side and adapted to pivot from a vertical position to a horizontal position to be folded within the base frame. Similarly, the second sidewall is pivotally coupled to the rear frame side and adapted pivot from a vertical position to a horizontal position to be folded within the base frame.

In one embodiment, when transporting a loaded pallet, the loaded pallet rests on the base frame when the first and second sidewalls are each folded within the base frame. In one embodiment, when transporting loose materials, such as packaging from the load carried on the pallet, the loose materials rest on the base frame and between the first and second sidewalls when the first and second sidewalls are each in the vertical position.

In one embodiment, the first sidewall is both pivotally and slideably coupled to the front frame side, and the second sidewall is both pivotally and slideably coupled to the rear frame side. This allows the first and second sidewalls to be folded within the base frame in any order.

In one embodiment, the pallet cart includes a coupling mechanism adapted to couple the pallet cart to a second pallet cart to form a single extended pallet cart for transporting loads having an extended length. The coupling mechanism couples the rear frame side of the cart to a front frame side of the second cart when said rear and front frame sides are facially abutted together.

In one embodiment, the coupling mechanism includes a sliding plate located adjacent the rear frame side and driven by a linkage. The sliding plate includes a feature adapted to engage a protrusion extending forwardly from the front frame side of the second cart.

In one embodiment, at least one of the castor wheels is normally locked to prevent the castor wheel's rotation about the castor wheel's vertical axis or post. When the coupling mechanism is used to couple the pallet cart to the second pallet cart, the coupling mechanism unlocks the castor wheel to allow the castor wheel's free rotation about the castor wheel's vertical axis or post.

In one embodiment, for a first pallet cart, a tongue is pivotally coupled to the base frame near the front frame side, and a hitch is coupled to the base frame near the rear frame side. The hitch is adapted to funnel a free end of a tongue of a second pallet cart into the hitch and the hitch is biased to engage the free end.

In one embodiment, for a first pallet cart, the first and second sidewalls are configured to form a plurality of pockets within the base frame when the first and second sidewalls are folded down within the base frame. Thus, when a second pallet cart that has a plurality of castor wheels is stacked on top of the first pallet cart, the plurality of pockets of the first pallet cart receives the plurality of castor wheels of the second pallet cart.

In one embodiment, a structure is attached to a bottom portion of a first pallet cart and is adapted to receive forklift or pallet jack teeth. In one embodiment, the structure includes a pair of channel like members adapted to receive forklift or pallet jack teeth. The channel like, members run generally latitudinally across the pallet cart. The channel like members also have a pair of notches adapted to receive forklift or pallet jack teeth running generally perpendicularly to the channel like members. Furthermore, in one embodiment, the structure includes a first set of notches adapted to mate with a second set of notches in an upper edge of a base frame of a second pallet cart when the first pallet cart is stacked on top of the second pallet cart.

The present invention, in one embodiment, is a method of transporting loaded pallets to a location within a facility and/or transporting loose materials from said location. The method comprises providing a first pallet cart, a second pallet cart and a powered pulling device. The first pallet cart includes a base frame, a plurality of castor wheels attached to the base frame, sidewalls pivotally coupled to the base frame, a hitch attached to the base frame, and a tongue pivotally coupled to the base frame. The second pallet cart includes a base frame, a plurality of castor wheels attached to the base frame, sidewalls pivotally coupled to the base frame, a hitch attached to the base frame, and a tongue pivotally coupled to the base frame. The tongue of the first pallet cart is hitched to the powered pulling device, and the tongue of the second pallet cart is hitched to the hitch of the first pallet cart. Each sidewall is pivoted into a folded position within the base frame of the respective pallet cart, and a loaded pallet is placed on the base frame of each pallet cart. The powered pulling device is then used to pull the pallet carts in train-like fashion to the location within the facility.

Upon arrival at the location, the pallets are unloaded from the pallet carts, and packaging materials, if any, are removed from the pallet loads. The second pallet cart is unhitched from the first pallet cart and stacked on top of the first pallet cart. The sidewalls of the second pallet cart are pivoted into a vertical position to form a compartment. The loose materials (i.e., packaging materials) are placed within the compartments, and the powered pulling device is used to pull the stacked pallets with the loose materials away from location.

The features, utilities, and advantages of various embodiments of the invention will be apparent from the following more particular description of embodiments of the invention as illustrated in the accompanying drawings and defined in the appended claims.

### BRIEF DESCRIPTION OF THE DRAWINGS

FIG. 1 is a rear isometric view of one embodiment of the pallet cart of the subject invention.

FIG. 2 is a side elevation of multiple pallet carts hitched in a train-like fashion to a powered pulling device and carrying loaded pallets.

FIG. 3 is a rear elevation of the pallet cart with a pallet thereon.

FIG. 4 is a side elevation of multiple pallet carts stacked within each other.

FIG. 5 is a rear elevation of multiple pallet carts stacked within each other.

FIG. 6 is a rear isometric view of the pallet cart with one of its sides pivoted outward into a relatively horizontal orientation to facilitate loading of the pallet cart with packing materials.

FIG. 7 is a front isometric view of the pallet cart with its sides folded down within the frame of the cart.

FIG. 8 is a bottom isometric view of the rear portion of the pallet cart wherein a portion of the rear frame end is cut away to reveal the side/frame coupling arrangement and the rear channel-like member is shown in hidden lines to reveal a linkage arrangement.

FIG. 9 is a left side elevation wherein one of the sides is in the fully upright position and the left frame side is shown transparent to reveal the other three sides folded down within the frame.

FIG. 10 is a rear isometric view of a pallet cart including a side that has an upper section and a lower section and wherein the upper section may disconnect from, or pivot outwardly relative to, the lower section to facilitate loading loose materials into the cart.

FIG. 11 is a rear isometric view of a pallet cart including a side that is a partial side (i.e., a side that has a height that is less than the height of a standard side) to facilitate loading loose materials into the cart.

FIG. 12 is a side elevation of the hitch engaging the tongue.

### DETAILED DESCRIPTION OF THE INVENTION

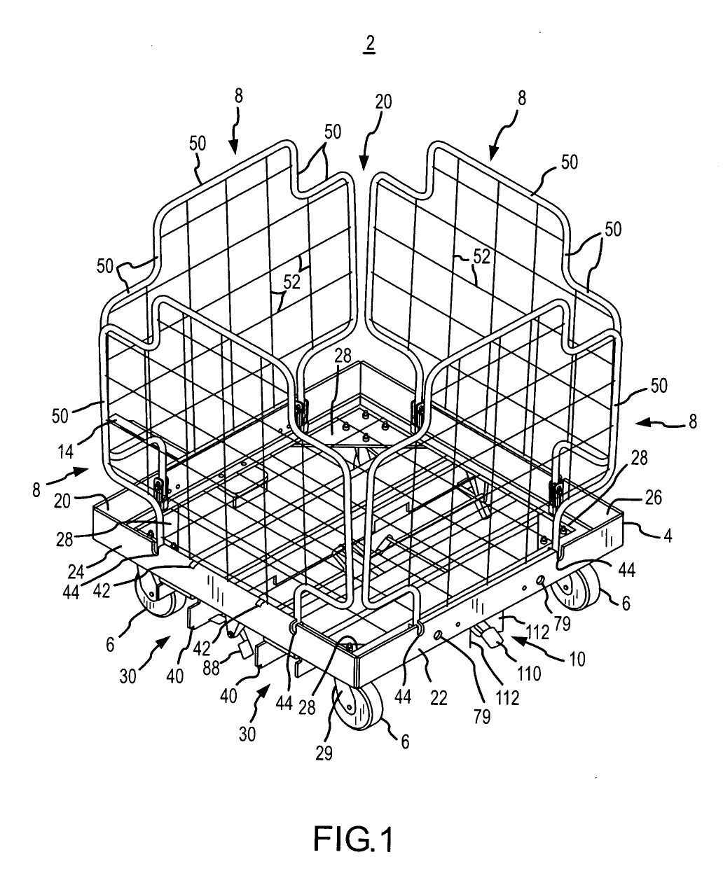

FIG. 1 is a rear isometric view of one embodiment of the pallet cart 2 of the subject invention. As indicated in FIG. 1, in one embodiment, the pallet cart 2 includes a base frame 4, castors 6, sides 8 and a hitch 10.

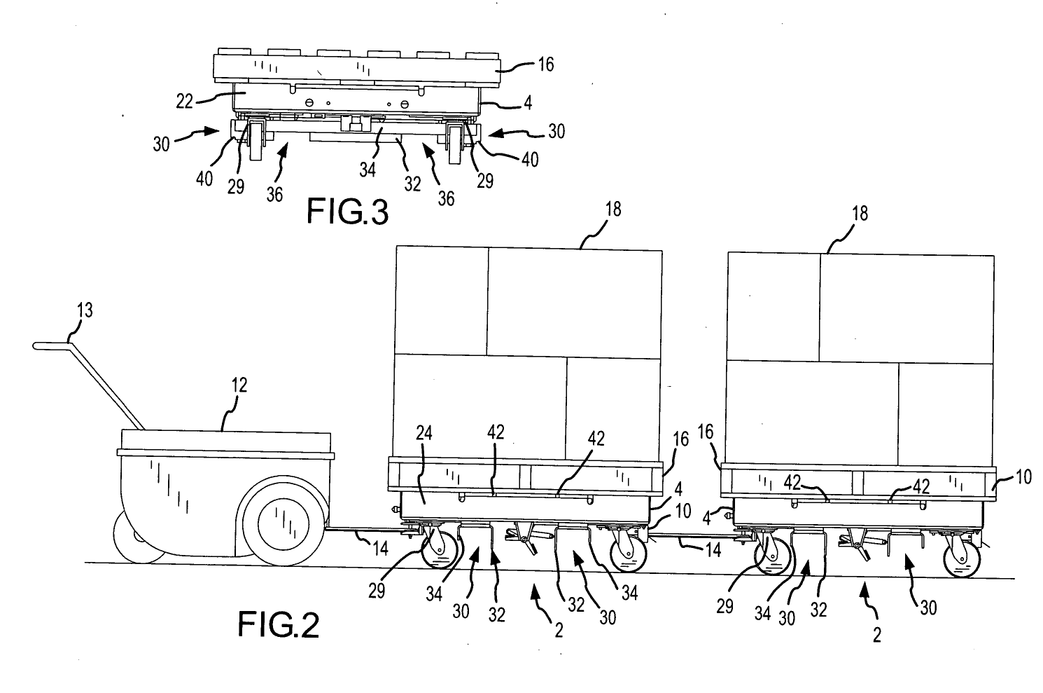

As indicated in FIG. 2, which is a side elevation of multiple pallet carts 2 hitched in a train-like fashion to a powered pulling device 12, the carts 2 may be equipped with a tongue 14 adapted to hitch to the hitch 10, and the sides 8 may be folded down within the base frame 4 to allow the base frame 4 to serve as a platform on which a pallet 16 may rest. Thus, as can be understood from FIG. 2, one or more carts 2 may be hitched in a string to a powered pulling device 12 for transferring multiple pallets 16 with their respective product loads 18 through a factory, warehouse, retail or similar facility. Also, as can be understood from FIGS. 1 and 2, after the pallets 16 have been delivered to their respective final locations within the facility and the packing materials have been removed from the product loads 18, the sides 8 may be placed in the upright position to form a container 20 as indicated in FIG. 1. The packing materials may then be loaded into the cart 2 and transported to the facility's trash disposal site.

The cart pallet 2 of the subject invention is advantageous because it allows many pallets to be moved in one trip through a facility without obstructing the user's view of the path to be traveled or requiring the user to contort his body in order to observe the path to be traveled. Thus, the cart pallet 2 saves time and decreases accidents and injuries. In one embodiment, the pallet carts 2 are configured such that at least four carts 2 and a powered pulling device 12 may be hitched together in train-like fashion and be able to negotiate an intersection formed by an eight foot aisle intersecting a ten foot aisle at a right angle.

In one embodiment, as depicted in FIG. 2, the powered pulling device 12 is a motorized device adapted to pull loads wherein the user walks along while guiding the device 12 via a control handle 13. In one embodiment, such a device 12 is a PowerPal 3100 as manufactured by Dane Industries at 7105 Northland Terrace, Brooklyn Park, Minn. 55428.

In one embodiment, the powered pulling device 12 is a rideable device such as a forklift, small tractor, golf cart, etc. Similar to the towing arrangement depicted in FIG. 2, the carts 2 are simply hitched in a train-like fashion to the rideable powered pulling device 12.

For a discussion of the base frame 4 of the pallet cart 2, reference is again made to FIGS. 1 and 2 and also to FIG. 3, which is a rear elevation of the pallet cart 2 with a pallet 16 thereon. As indicated in FIG. 1, the base frame 4 includes a front or tongue end 20, a rear or hitch end 22, a left side 24, and a right side 26. As shown in FIG. 1, the end of each side 20, 22, 24, 26 forms a corner with the end of the adjacent side. Thus, in one embodiment, the sides 20, 22, 24, 26 form a generally rectangular base frame 4, which in one embodiment is generally square. In one embodiment, the base frame 4 is formed from metals (e.g., aluminum, steel, etc.), polymers, or composite materials containing polymers and reinforcing fibers. In one embodiment, the base frame 4 and the castors 6 are such that the carts 2 will support a 2000-pound load.

As indicated in FIG. 1, where each pair of sides 20, 22, 24, 26 joins together to form a corner of the base frame 4, a reinforcement plate 28 extends across the bottom of each corner and joins to each side 20, 22, 24, 26 forming the respective corner. A castor 6 is bolted to, and extends downward from, each reinforcement plate 28.

In one embodiment, a pallet cart 2 will have four castor wheels 6. In other embodiments, a pallet cart 2 will have a greater or lesser number of castor wheels 6. In one embodiment, two front castor wheels 6 will freely pivot about their respective vertical mounting posts 29, while at least one of the two rear castor wheels 6 will normally be locked (i.e., restrained) from pivoting freely about their respective vertical mounting posts 29. By locking at least one of the castor wheels 6, the pallet cart 2 becomes more maneuverable and steerable. As will be explained later in this Detailed Description, in one embodiment, a normally locked castor 6 may be selectively unlocked to allow it to freely pivot about its vertical mounting post 29.

As shown in FIGS. 1-3, a pair of channel-like members 30 extends downward from and longitudinally across the bottom of the base frame 4. The channel-like members 30 are on opposite sides of the longitudinal middle of the base frame 4 and are each offset an equal distance from said longitudinal middle. The channel-like members 30 are adapted to receive forklift teeth to allow a forklift (or pallet jack) to elevate the cart 2 when approaching the left or right sides 24, 26 of the cart 2.

As most clearly indicated in FIG. 2, in one embodiment, an inner side 32 of each channel-like member 30 (i.e., the vertical side of each channel-like member 30 adjacent the longitudinal middle of the base frame 4) extends downward from the base frame 4 a greater distance than an outer side 34 of each channel-like member 30 (i.e., the vertical side of each channel-like member 30 more distant from the longitudinal middle of the base frame 4). As illustrated in FIG. 3, each inner side 32 has a pair of notches 36 defined therein and offset an equal distance from the latitudinal middle of the base frame 4. The notches 36 are adapted to receive forklift teeth to allow a forklift (or pallet jack) to elevate the cart 2 when approaching the front or rear ends 20, 22 of the cart 2.

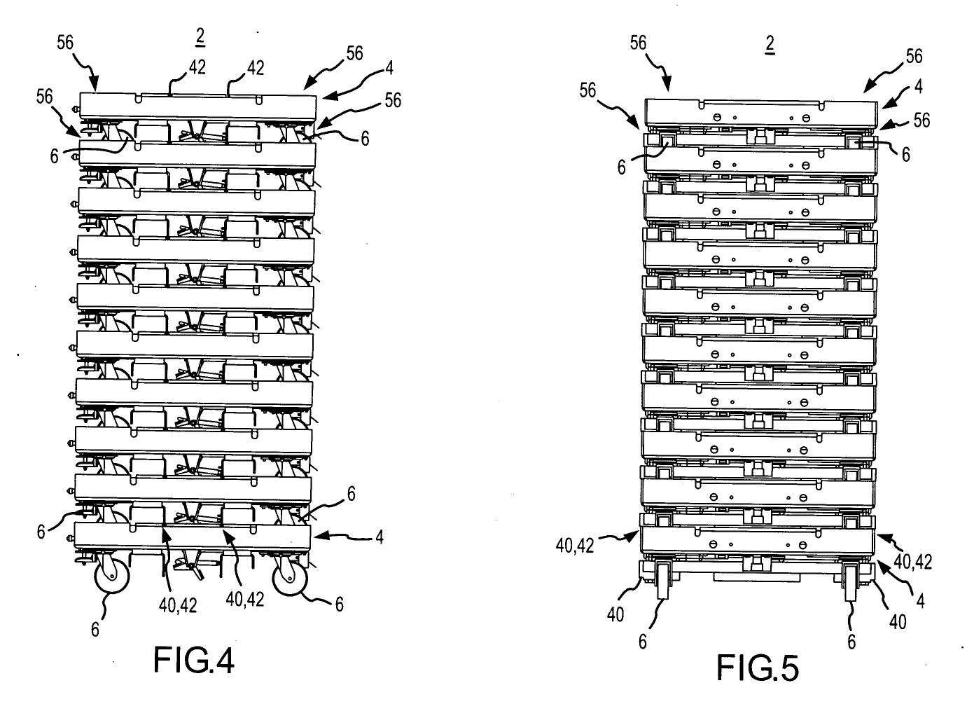

As shown in FIGS. 1-3, in one embodiment, the ends of each inner side 32 have notches 40, and the top edge of each side 24, 26 has a pair of notches 42. As can be understood from FIG. 2 and as more fully illustrated in FIGS. 4 and 5, which are, respectively, a side elevation and a rear elevation of multiple carts 2 stacked within each other, each notch 40 on the end of each inner side 32 is received in, and mates with, a corresponding notch 42 in the top edge of each side 24, 26. Thus, the mating of the notches 40, 42 helps to interlock the carts 2 when stacked to provide a stable and sturdy stack of carts as depicted in FIGS. 4 and 5. The stackable nature of the pallet carts 2 saves floor space within a facility and reduces the number of trips made while transporting empty carts 2 because the carts 2 can be moved in stacks.

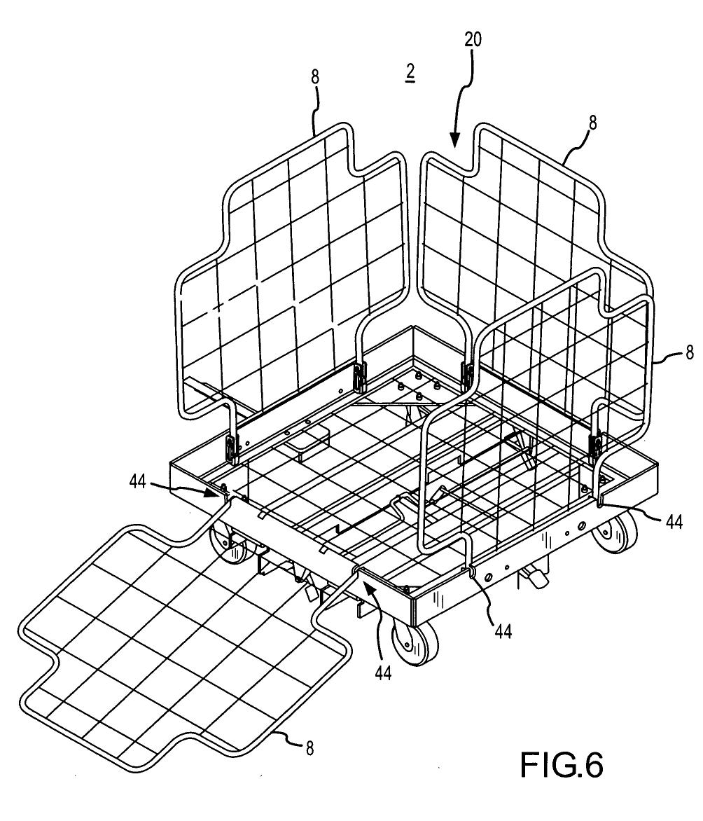

As shown in FIG. 1, the top edge of each frame end 20, 22 and frame side 24, 26 includes a pair of notches 44. These notches 44 provide outward pivoting clearance for the framework of the sides 8 when the sides 8 are pivoted outwards as illustrated in FIG. 6, which is a rear isometric view of the pallet cart 2 with one of its sides 8 pivoted outward into a relatively horizontal orientation. Thus, the notches 44 facilitate the sides 8 being laid generally flat to allow easier loading of packaging material into the container area 20 formed by the sides 8.

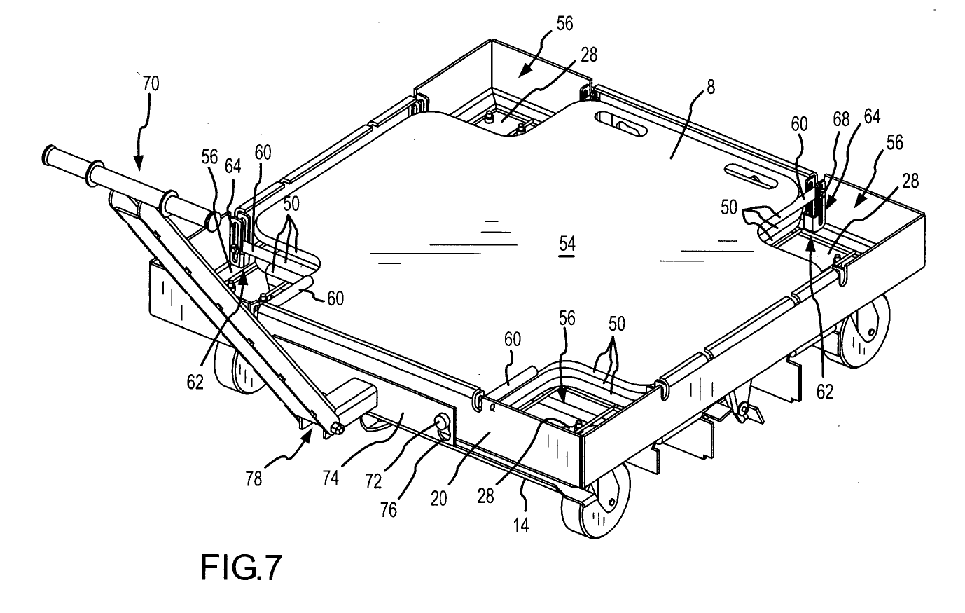

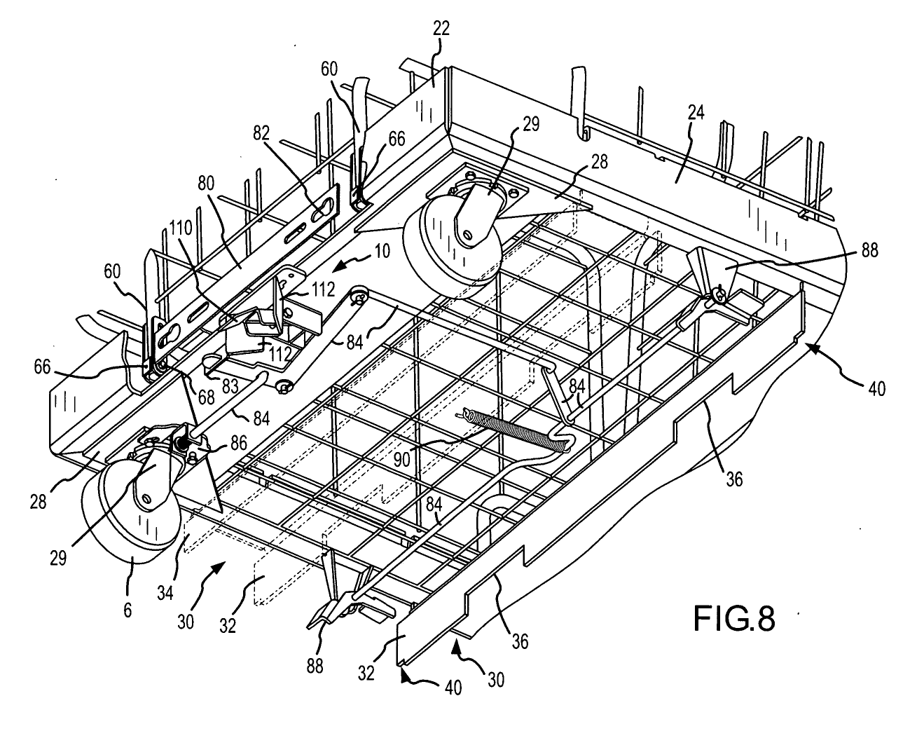

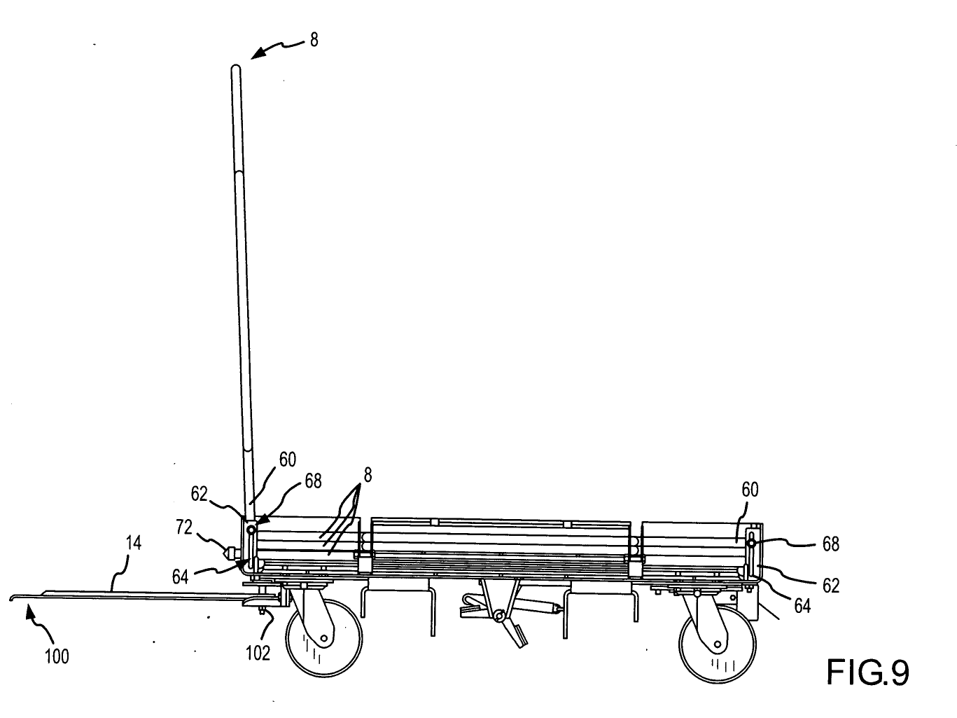

For a discussion of the sides 8 of the pallet cart 2 and the arrangement by which the sides 8 are coupled to the base frame 4, reference is again made to FIG. 1 and also to FIGS. 7, 8 and 9. FIG. 7 is a front isometric view of the pallet cart 2 with its sides 8 folded down within the frame 2 of the cart 2. FIG. 8 is a bottom isometric view of the rear portion of the pallet cart 2 wherein a portion of the rear frame end 22 is cut away to reveal the side/frame coupling arrangement and the rear channel-like member 30 is shown in hidden lines to reveal a linkage arrangement. FIG. 9 is a left side elevation wherein one of the sides 8 is in the fully upright position and the left frame side 24 is shown transparent to reveal the other three sides 8 folded down within the frame 4.

As indicated in FIG. 1, in one embodiment, each side 8 is defined by an outer framework 50 that forms a plus-mark or cross-type shape (e.g., a generally square or rectangular shape wherein the corners extend inwards instead of outwards). In one embodiment, as depicted in FIG. 1, a webbing or mesh 52 extends between the framework 50 portions of each side 8. In one embodiment, as illustrated in FIG. 7, a generally solid, continuous surface 54 extends between the framework 50 portions of each side 8. In one embodiment, the sides 8 may be formed of metal (e.g., aluminum, steel, etc.), polymer, wood, or fabric.

In one embodiment, as can be understood from FIG. 7, three of the sides 8 have webbing or mesh 52 and the fourth side 8 has a generally solid, continuous surface 54. The three mesh equipped sides 8 may be folded down within the base frame 4 first and the generally solid, continuous surface equipped side 8 may be folded down last (i.e., placed on top of the mesh equipped sides). The aforementioned side configuration and folding order allows the cart 4 to serve as a customer shopping platform-type cart when not employed as a pallet cart 2.

As can be understood from FIG. 1 and as best illustrated in FIG. 7, the plus-mark or cross-type shape of the framework 50 forms generally square open volumes or spaces 56 in the corners of the base frame 4 when the sides 8 are folded down within the base frame 4. These open volumes or spaces 56 are located over the reinforcing plate 28 to which the castors 6 are coupled, as discussed above and illustrated in FIG. 1. Thus, as indicated in FIGS. 4 and 5, when the carts 2 are stacked, the castors 6 of an upper cart 2 reside within the spaces 56 of the cart 2 immediately below said upper cart 2. This arrangement helps to minimize the overall height of a stack of carts 2 and increases the interlocking stability of the stack.

As discussed above and more clearly indicated in FIG. 9, the sides 8 may be positioned vertically on the cart 2 or the sides 8 may be folded down and stacked within the base frame 4. As shown in FIGS. 7-9, this is in part made possible by the arrangement used to couple the sides 8 to the base frame 4. In one embodiment, said coupling arrangement includes a pair of posts 60 that extend downward from the framework 50 portions of each side 8 into brackets 62 attached to the sides 20, 22, 24, 26 of the base frame 4. Each bracket 62 has a vertical slot 64 and a walled base portion 66 (i.e., a restraining cavity) for receiving the extreme end of a post 60 and maintaining the post 60 and, as a result, the respective side 8 in a vertical position as depicted in FIGS. 1 and 8. As illustrated in FIGS. 7 and 9, each extreme end of a post 60 is pivotally and vertically slidably coupled to its respective vertical slot 64 via a pin 68. Thus, the pins 68 and vertical slots 64 cooperate to allow the sides 8 to pivot about their respective pins 68 between a vertical position, as depicted in FIG. 1, and generally horizontal positions as depicted in FIGS. 6, 7 and 9. Also, the pins 68 and vertical slots 64 cooperate to allow the sides 8 to stack within the base frame 4 (as indicated in FIGS. 7 and 9) such that the pins 68 of the lowest side 8 rest at the lowest levels within their respective slots 64, the pins 68 of the second lowest side 8 rest at the second lowest levels within their respective slots 64, the pins 68 of the third lowest side 8 rest at the third lowest levels within their respective slots 64, and the pins 68 of the highest side 8 rest at the highest levels within their respective slots 64. As can be understood from the discussion and referenced figures, the pins 68, slots 64 and sides 8 are configured such that the sides can be folded within the base frame 4 in any order.

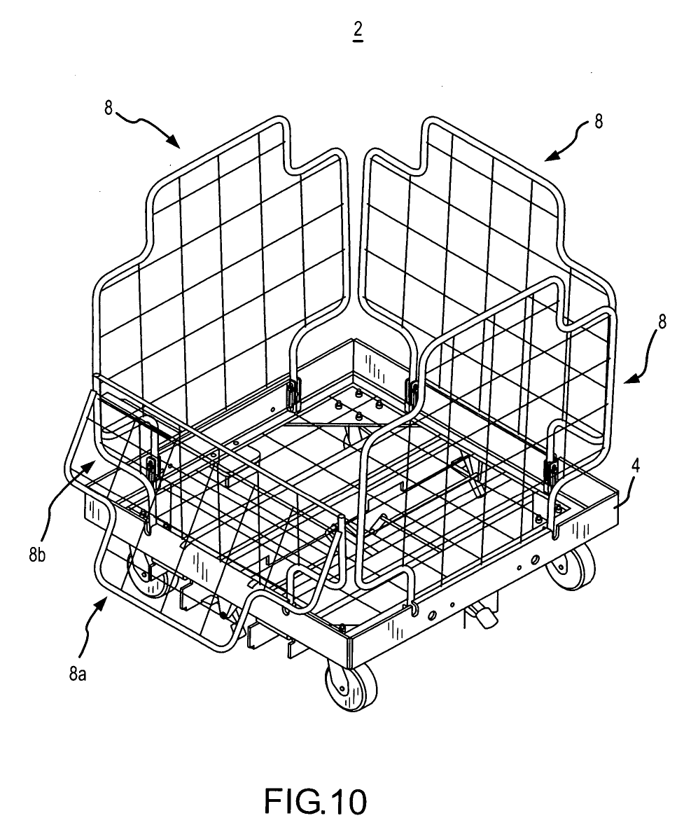

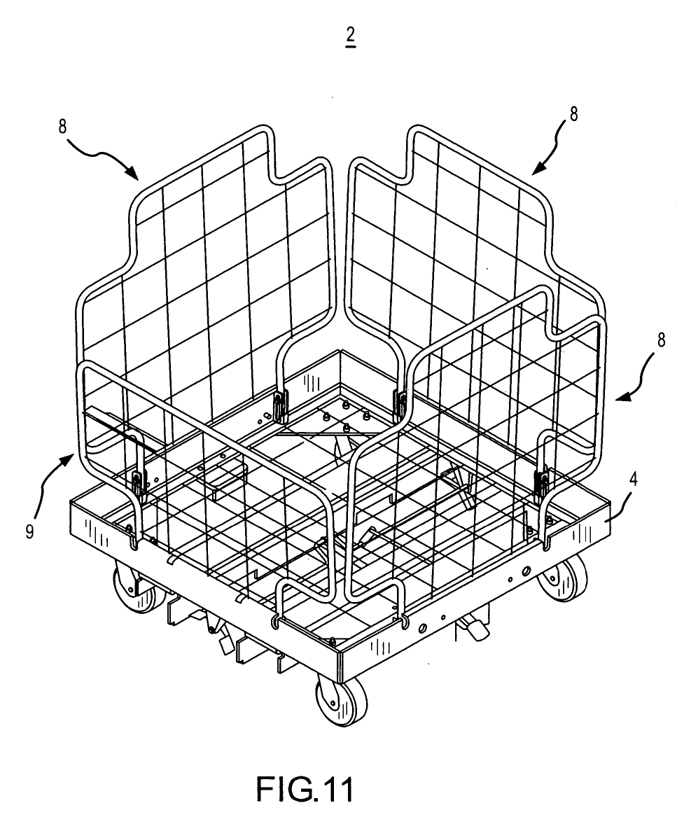

As previously discussed in reference to FIG. 6, the sides 8 of a cart 2 may be pivoted outwardly about their respective pins 68 and slots 64 to a generally horizontal orientation in order to facilitate loading loose materials (e.g., packing materials) into the cart 2. In one embodiment, as depicted in FIG. 10, which is a rear isometric view of a pallet cart 2, one or more of the sides 8 have an upper section 8a and a lower section 8b wherein the upper section 8a may disconnect from, or pivot outwardly relative to, the lower section 8b to facilitate loading loose materials into the cart 2. In another embodiment, as depicted in FIG. 11, which is a rear isometric view of a pallet cart 2, one or more of the sides 8 are partial sides 9 (i.e., a side 8 that has a height that is less than the height of a standard side 8) to facilitate loading loose materials into the cart 2. In one embodiment, the partial side 9 is half the height of the other full sized sides 8.

For a discussion of an arrangement for manually pulling a pallet cart 2, reference is again made to FIG. 7. As indicated in FIG. 7, to facilitate manual movement of the cart 2, a handle 70 may be attached to the front end 20 of the base frame 4. In one embodiment, projections or pegs 72 forwardly extend from the front side 20, and a faceplate 74 at the base of the handle has key slots 76 for receiving the pegs 72. The faceplate 74 is abutted against the front side 20 such that the pegs 72 are received within the key slots 76. The faceplate 74 is then displaced downwardly against the front side 20 until the pegs 72, which each have an enlarged head, reside within a narrowed section of the key slots 76. In other embodiments, depending on the orientation of the slots 76, the faceplate 74 can be displaced upwardly or sideways to cause the pegs 72 to reside within the narrowed section of the key slots 76. The handle 70 is now securely coupled to the cart 2. In one embodiment, the handle has a pivot point 78 near the faceplate 74.

In one embodiment, the handle does not have a faceplate 74, but is instead equipped with an end similar to the tongue end discussed later in this Detail Description. The handle 70 then hitches to the hitch 10 as described later.

For a discussion of an arrangement for attaching two or more of the carts 2 together to form a single extended cart for carrying loads having an extended length, reference is again made to FIGS. 1, 7 and 8. As shown in FIG. 1, the rear side 22 of the base frame 4 includes holes 79 for receiving the projections or pegs 72 of another cart 2.

As indicated in FIG. 8, in one embodiment, the rear side 22 of the base frame 4 includes a sliding plate 80 equipped with key slots 82 having a narrower portion and oriented generally horizontally. A tab 83 extends from the bottom edge of the sliding plate 80 and is coupled to a linkage 84. In one embodiment, the linkage 84 is also coupled to a castor locking mechanism 86. The linkage 84 is actuated by foot pedals 88 located on the left and right sides 24, 26 of the base frame 4.

As can be understood from FIGS. 1, 7 and 8, the projections or pegs 72 of a first cart 2 may be inserted into the holes 79 of a second cart 2. A cart user then steps on the foot pedals 88 of the second cart to cause the linkage 84 to displace the sliding plate 80 sideways to cause the pegs 72 to reside in the narrow sections of the key slots 82 of a second cart 2. This couples the first and second carts 2 together to form a single unitary cart having an extended length for carrying extended loads.

Stepping on the foot pedals 88 also causes the linkage 84 to disengage the castor locking mechanism 86 that normally locks at least one castor 6 on a cart 2 to prevent the castor 6 from pivoting about its vertical axis 29 and allowing the cart 2 to be maneuvered or steered. As indicated in FIG. 8, a spring 90 maintains the linkage 84 in one of its two positions, which are a first position where the castor locking mechanism 86 is engaged and the sliding plate 80 is aligned to release any pegs 72, and a second position where the castor locking mechanism 86 is disengaged and the sliding plate 80 is aligned to engage pegs 72.

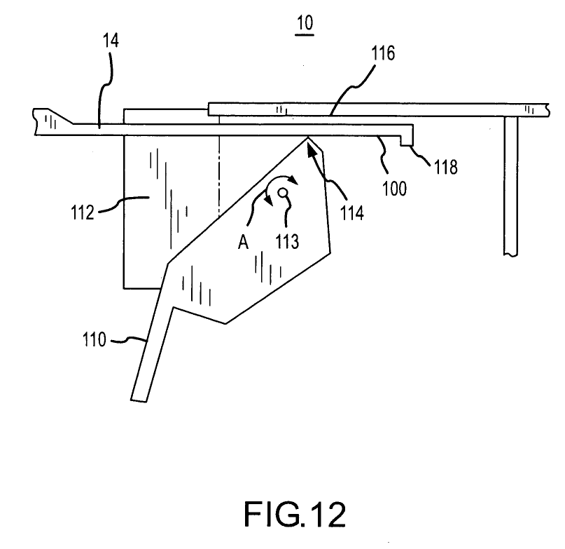

For a discussion of the features of the tongue 14 and hitch 10, reference is now made to FIGS. 6-9 and 12. FIG. 12 is a side elevation of the hitch 10 engaging the tongue 14. As shown in FIGS. 7 and 9, the tongue 14 includes a tip 100 adapted to engage the hitch 10 and is pivotally attached to the front of the base frame 4 via a tongue pin 102. The tongue 14 may be extended directly forward, to the side such that it is recessed under the base frame 4, or any angle between directly forward or to the side. In one embodiment, the tongue 14 is hinged to fold backwards underneath the base frame 4 of the cart and retained in position via a spring and/or some retaining members.

As illustrated in FIGS. 1, 8 and 12, the hitch 10 includes a horizontally pivotable guide 110 and two side guides 112. The horizontally pivotable guide 110 is pivotable about a pin 113 in the directions indicated by pivot arrow A. When the tongue tip 100 approaches the hitch 10, the guides 110, 112 serve to direct (i.e., funnel) the tongue tip 100 into the hitch 10 as indicated in FIG. 12. The horizontally pivotable guide 110 is counterweighted such that its inward tip 114 is biased via gravity to rest against the top inner surface 116 of the hitch 10. Thus, when the tongue tip 100 enters the hitch 10, the tongue tip 100 is prevented from withdrawing from the hitch 10 because a lip 118 of the tongue tip 100 engages the inward tip 114 of the horizontally pivotable guide 110. To release the tongue 14 from the hitch 10, the tongue 14 must be retracted from the hitch 10 when the pivotable guide 110 is pivoted about the pin 113 such that the inward tip 114 moves away from the top inner surface 116 of the hitch 10. The pivotable guide 110 may be caused to so rotate by lightly applying a force to the outermost end of the pivotable guide 110.

Although various embodiments of this invention have been described above with a certain degree of particularity or with reference to one or more individual embodiments, those skilled in the art could make numerous alterations to the disclosed embodiments without departing from the spirit or scope of this invention. It is intended that all matter contained in the above description and shown in the accompanying drawings shall be interpreted as illustrative only of particular embodiments, and not limiting. Changes in detail or structure may be made without departing from the basic elements of the invention as defined in the following claims.

What is claimed is:

1. A pallet cart adapted to transport a pallet and/or loose materials between locations within a facility, the pallet cart comprising:
a base frame;
a plurality of wheels coupled to the base frame;
a first side wall pivotally coupled to the base frame and adapted to pivot from a vertical position to a horizontal position to be folded within the base frame; and
a second sidewall pivotally coupled to the base frame and adapted pivot from a vertical position to a horizontal position to be folded within the base frame,
wherein when the first and second sidewalls are each folded within the base frame, the pallet cart is configured to receive the pallet;
wherein when the first and second sidewalls are each in the vertical position, the pallet cart is configured to receive the loose materials between the first and second sidewalls.

2. The pallet cart of claim 1, wherein the first sidewall is both pivotally and slideably coupled to the base frame and the second sidewall is both pivotally and slideably coupled to the base frame, thereby allowing the first and second sidewalls to be folded within the base frame in any order.

3. The pallet cart of claim 1, further comprising a coupling mechanism adapted to couple the pallet cart to a second pallet cart of the same configuration to form a single extended pallet cart.

4. The pallet cart of claim 3, wherein the base frame of each pallet cart includes a front frame side and a rear frame side and wherein said coupling mechanism couples the rear frame side of the pallet cart to a front frame side of the second pallet cart when said rear and front frame sides are aligned with each other in close proximity.

5. The pallet cart of claim 4, wherein the coupling mechanism includes a sliding plate located adjacent the rear frame side of the pallet cart, and wherein the sliding plate includes a feature adapted to engage a protrusion extending forwardly from the front frame side of the second pallet cart.

6. The pallet cart of claim 5, wherein the sliding plate is displaced via a linkage operably coupled to a lever adapted for foot or hand engagement.

7. The pallet cart of claim 3, where each wheel is pivotal about a respective vertical axis or post extending downward from the base frame.

8. The pallet cart of claim 7, wherein at least one of the wheels is normally locked to prevent the wheel's rotation about the wheel's vertical axis or post, and causing the coupling mechanism to couple the pallet cart to the second pallet cart unlocks said wheel to allow the wheel's free rotation about the wheel's vertical axis or post.

9. The pallet cart of claim 1, wherein the pallet cart further comprises a tongue and a hitch.

10. The pallet cart of claim 9, wherein the hitch of the pallet cart is adapted to funnel a free end of a tongue of a second pallet cart into the hitch and the hitch is biased to engage said free end.

11. The pallet cart of claim 9, wherein the base frame of each pallet cart includes a front frame side and a rear frame side, the tongue is pivotally coupled to the base frame near the front frame side, and the hitch is coupled to the base frame near the rear frame side.

12. The pallet cart of claim 1, wherein the first and second sidewalls are configured to form a plurality of pockets within the base frame when the first and second sidewalls are folded down within the base frame.

13. The pallet cart of claim 12, wherein, when a second pallet cart that has a plurality of wheels is stacked on top of the pallet cart, the plurality of pockets receives the plurality of wheels of the second pallet cart.

14. The pallet cart of claim 1, further including a structure attached to a bottom portion of the pallet cart and adapted to receive forklift or pallet jack teeth.

15. The pallet cart of claim 14, wherein the structure includes a pair of channel like members running generally parallel to each other across the pallet cart.

16. The pallet cart of claim 15, wherein the channel like members have a pair of notches adapted to receive forklift or pallet jack teeth running generally perpendicularly to the channel like members.

17. The pallet cart of claim 14, wherein the structure includes a first set of notches adapted to mate with a second set of notches in an upper edge of a base frame of a second pallet cart when the pallet cart is stacked on top of the second pallet cart.

18. A method of transporting at least one loaded pallet within a facility, the method comprising:
providing a first pallet cart including a base frame, a plurality of wheels operably coupled to the base frame, and sidewalls pivotally coupled to the base frame;
pivoting the sidewalls of the first pallet cart into a folded position within the base frame of the first pallet cart; and
supporting a loaded pallet off the base frame of the first pallet cart.

19. The method of claim 18, further comprising coupling a second pallet cart to the first pallet cart, wherein the second pallet cart includes a base frame, a plurality of wheels operably coupled to the base frame, and sidewalls pivotally coupled to the base frame

20. The method of claim 19, wherein the pallet carts are coupled together in a train-like fashion.

21. The method of claim 19, further comprising coupling the first pallet cart to a powered pulling device.

22. The method of claim 19, further comprising causing the coupled first and second pallet carts to travel to a first facility location.

23. The method of claim 22, further comprising removing the loaded pallet from the first pallet cart at the first facility location.

24. The method of claim 22, further comprising pivoting the sidewalls of at least one of said pallet carts into a vertical position such that an enclosure is generally formed by said sidewalls.

25. The method of claim 24, further comprising placing loose materials in the enclosure generally formed by said sidewalls.

26. The method of claim 25, wherein the loose materials are packing materials removed from the loaded pallet.

27. The method of claim 25, further comprising causing the coupled first and second pallet carts to travel to a second facility location where the loose materials are removed from the enclosure.

28. A pallet cart transformable between a platform configuration and an enclosure configuration.

29. The pallet cart of claim 28, wherein the platform configuration allows the pallet cart to support a pallet for transport.

30. The pallet cart of claim 28, wherein the enclosure configuration allows the pallet cart to retain loose materials for transport.

31. The pallet cart of claim 28, including a coupling arrangement adapted to couple the pallet cart with a second pallet cart to form a single extended pallet cart.

32. The pallet cart of claim 31, further comprising a locking mechanism and a wheel normally non-pivotal about a vertical axis, wherein when the coupling arrangement is used to couple the pallet cart to the second pallet cart, the locking mechanism is caused to release such that the wheel becomes free to pivot about the vertical axis.

33. The pallet cart of claim 28, including a coupling arrangement adapted to couple the pallet cart with a second pallet cart in a train-like manner.

34. The pallet cart of claim 28, including a coupling arrangement adapted to couple the pallet cart to a powered transport device.

35. The pallet cart of claim 28, further comprising wheels and wherein the pallet cart is configured such that when a similarly configured pallet cart is stacked on the pallet cart, the wheels of the similarly configured pallet cart are recessably received by the pallet cart.
